(19) United States
(12) Patent Application Publication
(10) Pub. No.: US 2023/0345524 A1
(43) Pub. Date: Oct. 26, 2023

(54) PRACH FOR COVERAGE ENHANCEMENTS

(71) Applicant: Samsung Electronics Co., Ltd., Suwon-si (KR)

(72) Inventors: Jung Hyun BAE, San Diego, CA (US); Mohammed KARMOOSE, San Diego, CA (US); Mohamed AWADIN, San Diego, CA (US)

(21) Appl. No.: 18/168,540

(22) Filed: Feb. 13, 2023

Related U.S. Application Data
(60) Provisional application No. 63/335,116, filed on Apr. 26, 2022.
(60) Provisional application No. 63/434,881, filed on Dec. 22, 2022.

(51) Int. Cl. H04W 74/00; H04W 74/08

(52) U.S. Cl. CPC H04W 74/004; H04W 74/0833

(57) ABSTRACT

A system and a method are disclosed for PRACH for coverage enhancements. In some embodiments, the method includes: transmitting, by a User Equipment (UE), a first Physical Random Access Channel (PRACH) transmission in a first Random Access Channel Occasion (RO); and transmitting, by the UE, a second PRACH transmission in a second RO, the second PRACH transmission being a repetition of the first PRACH transmission, the second RO having an index differing from an index of the first RO by a set integer.

### CROSS-REFERENCE TO RELATED APPLICATIONS

This application claims the priority benefit under 35 U.S.C. § 119(e) of U.S. Provisional Application No. 63/335,116, filed on Apr. 26, 2022, and of U.S. Provisional Application No. 63/434,881, filed on Dec. 22, 2022, the disclosures of both of which are incorporated by reference in their entirety as if fully set forth herein.

### TECHNICAL FIELD

The disclosure generally relates to wireless communications. More particularly, the subject matter disclosed herein relates to improvements to the handling of Physical Random Access Channel (PRACH) transmissions in wireless networks with coverage enhancements.

### SUMMARY

In a wireless communications system, such as a mobile telephony system, the coverage of the wireless network may be a factor limiting the overall performance of the system.

To solve this problem, various approaches may be used to enable reliable communications in low signal-to-noise ratio conditions. For example, certain transmissions generated by a User Equipment, such as Physical Random Access Channel (PRACH) transmissions, may be repeated. One issue with the above approach is that various parameters, such as a preamble, may need to be selected for each repeated transmission. To overcome these issues, systems and methods are described herein for selecting parameters to be used in each PRACH repetition. The above approaches improve on previous methods because, for example, they may reduce the decoding complexity for the network node (gNB).

According to an embodiment of the present disclosure, there is provided a method, including:

transmitting, by a User Equipment (UE), a first Physical Random Access Channel (PRACH) transmission in a first Random Access Channel Occasion (RO); and transmitting, by the UE, a second PRACH transmission in a second RO, the second PRACH transmission being a repetition of the first PRACH transmission, the second RO having an index differing from an index of the first RO by a set integer.

In some embodiments, the first RO is associated with a first Synchronization Signal Block (SSB) index, and the second RO is associated with the first SSB index.

In some embodiments, the first PRACH transmission uses a first uplink (UL) beam, and the second PRACH transmission uses a second UL beam differing from the first UL beam.

In some embodiments, the set integer is Radio Resource Control (RRC) configured.

In some embodiments, the set integer is configured by a System Information Block.

In some embodiments, the set integer is configured at startup of the UE.

In some embodiments: the first PRACH transmission includes a first preamble, having a first preamble index; and the second PRACH transmission includes a second preamble, having a second preamble index differing from the first preamble index by a set integer.

In some embodiments, the method includes transmitting L PRACH transmissions including: the first PRACH transmission; and L-1 PRACH repetitions including the second PRACH transmission, the L PRACH transmissions being in one SSB-RO association period.

In some embodiments, the first PRACH transmission is made on one of N′ ROs, the N′ ROs being a set proper subset of N available ROs.

In some embodiments, the set proper subset is Radio Resource Control (RRC) configured.

In some embodiments, the method includes transmitting L PRACH transmissions including: the first PRACH transmission; and L-1 PRACH repetitions including the second PRACH transmission, wherein the N′ ROs are selected based on the value of L.

According to an embodiment of the present disclosure, there is provided a method, including:

transmitting, by a User Equipment (UE), a first Physical Random Access Channel (PRACH) transmission including a first preamble, in a first RO; and transmitting, by the UE, a second PRACH transmission including a second preamble, in a second RO, the second PRACH transmission being a repetition of the first PRACH transmission, the first preamble being based on a first root sequence and being cyclically shifted by a first integer, and the second preamble being based on the first root sequence and being cyclically shifted by a second integer differing from the first integer by a set integer.

In some embodiments, the method includes transmitting L PRACH transmissions including: the first PRACH transmission; and L-1 PRACH repetitions including the second PRACH transmission, the L PRACH transmissions being in one SSB-RO association period.

In some embodiments, the first PRACH transmission is made on one of N′ ROs, the N′ ROs being a set proper subset of N available ROs.

In some embodiments, the set proper subset is Radio Resource Control (RRC) configured.

In some embodiments, the method includes transmitting L PRACH transmissions including: the first PRACH transmission; and L-1 PRACH repetitions including the second PRACH transmission, wherein the N′ ROs are selected based on the value of L.

According to an embodiment of the present disclosure, there is provided a User Equipment (UE) including: one or more processors; and a memory storing instructions which, when executed by the one or more processors, cause performance of: transmitting a first Physical Random Access Channel (PRACH) transmission in a first Random Access Channel Occasion (RO); and transmitting a second PRACH transmission in a second RO, the second PRACH transmission being a repetition of the first PRACH transmission, the second RO having an index differing from an index of the first RO by a set integer.

In some embodiments, the first RO is associated with a first Synchronization Signal Block (SSB) index, and the second RO is associated with the first SSB index.

In some embodiments, the first PRACH transmission uses a first uplink (UL) beam, and the second PRACH transmission uses a second UL beam differing from the first UL beam.

In some embodiments, the set integer is Radio Resource Control (RRC) configured.

### BRIEF DESCRIPTION OF THE DRAWINGS

In the following section, the aspects of the subject matter disclosed herein will be described with reference to exemplary embodiments illustrated in the figures, in which:

FIG. 1 is an illustration on of a 4-step Random Access Channel (RACH) procedure, according to an embodiment of the present disclosure;

FIG. 2A is an illustration of beams used in PRACH aggregated transmission, according to an embodiment of the present disclosure;

FIG. 2B is an illustration of beams used in PRACH aggregated transmission, according to an embodiment of the present disclosure;

FIG. 2C is an illustration of beams used in PRACH aggregated transmission, according to an embodiment of the present disclosure;

FIG. 3A is an illustration of a first example of uplink (UL) transmissions, according to an embodiment of the present disclosure;

FIG. 3B is an illustration of a second example of uplink (UL) transmissions, according to an embodiment of the present disclosure;

FIG. 3C is an illustration of an example of the behavior of a Rel-16 UE and a Rel-17 UE with 3-level PRACH aggregation, according to an embodiment of the present disclosure;

FIG. 4A illustrates a first order of cycling through relative Random Access Channel (RACH) Occasion (RO) index and Synchronization Signal Block (SSB) index, according to an embodiment of the present disclosure;

FIG. 4B illustrates a second order of cycling through relative RO index and SSB index, according to an embodiment of the present disclosure;

FIG. 4C illustrates a plurality of hypotheses a gNB may make, according to an embodiment of the present disclosure;

FIG. 4D is an illustration of the determination of PRACH aggregation level, according to an embodiment of the present disclosure;

FIG. 5A is an illustration of PRACH aggregation, according to an embodiment of the present disclosure;

FIG. 5B is an illustration of PRACH aggregation, according to an embodiment of the present disclosure;

FIG. 6A is an illustration of PRACH aggregation, according to an embodiment of the present disclosure;

FIG. 6B is an illustration of PRACH aggregation, according to an embodiment of the present disclosure;

FIG. 6C is an illustration of PRACH aggregation, according to an embodiment of the present disclosure;

FIG. 6D is an illustration of PRACH aggregation, according to an embodiment of the present disclosure

FIG. 7A is an illustration of a first example of beam selection by a UE and by a gNB, according to an embodiment of the present disclosure;

FIG. 7B is an illustration of a second example of beam selection by a UE and by a gNB, according to an embodiment of the present disclosure;

FIG. 7C is an illustration of a second example of beam selection by a UE, according to an embodiment of the present disclosure;

FIG. 7D is an illustration of a second example of beam selection by a UE, according to an embodiment of the present disclosure;

FIG. 8A is a diagram of a portion of a wireless system, according to some embodiments;

FIG. 8B is a flow chart of a method, according to some embodiments; and

FIG. 9 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. As used herein, the term “or” should be interpreted as “and/or”, such that, for example, “A or B” means any one of “A” or “B” or “A and B”.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

When used as an adjective, the word “set” means available to both the UE and the gNB at the time of its use. For example, the shift value P mentioned in Rule P1 below may be a set integer.

The present disclosure describes a procedure for Physical Random Access Channel (PRACH) enhancements in Coverage Enhancement (CE) scenarios. In the New Radio (NR) Fifth Generation of Mobile Telephony (5G) standard promulgated by the 3rd Generation Partnership Project (3GPP), a UE is designed to transmit different Uplink (UL) signals to the base station (gNB). In NR, a UE uses UL transmission to convey a variety of information to the gNB. In particular, the UE sends user data to the gNB in a particular configuration of time and frequency resources known as the Physical Uplink Shared Channel (PUSCH). Specifically, the Medium Access Control (MAC) layer provides user data which are intended to be delivered to the corresponding layer at the gNB side. The Physical (PHY) layer of the UE takes the MAC layer data as input and outputs the corresponding PUSCH signal through a PUSCH processing chain. Similarly, the UE sends control data to the gNB in what is referred to as the Physical Uplink Control Channel (PUCCH). The control data is referred to as the Uplink Control Information (UCI) and is considered as the payload to the PUCCH signal.

Conversely, a UE is designed to receive different downlink (DL) signals from the base station (gNB). Similar to UL, a UE receives DL transmission to retrieve a variety of information from the gNB. The UE receives user data from the gNB in a particular configuration of time and frequency resources known as the Physical Downlink Shared Channel (PDSCH). The PHY layer of the UE extracts data from the physical signal received on the PDSCH and provides it to the MAC layer. Similarly, the UE receives control data from the gNB in the Physical Downlink Control Channel (PDCCH). The control data is referred to as the Downlink Control Information (DCI) and is considered as the payload to the PDCCH.

A UE is provided with Search Space (SS) set configuration and control resource set (CORESET) configuration for monitoring DCI in a PDCCH in a serving cell. In particular, a SS set configuration provides PDCCH monitoring occasion information in the time domain and each monitoring occasion is associated with the CORESET configuration linked to the SS set configuration. A CORESET configuration provides a set of resource blocks (RB) and a symbol duration for PDCCH candidate monitoring where a PDCCH candidate consists of a set of control channel elements (CCE) depending on aggregation level. A CCE consists of 6 resource element groups (REGs) and each REG is a group of 12 consecutive resource elements (REs). In other words, a UE will monitor a set of REs for PDCCH candidates located in a specified time and frequency domain based on the CORESET and search space set configurations.

Another physical signal which is transmitted by the UE is referred to as the Physical Random Access Channel (PRACH). Similar to Long Term Evolution (LTE) cellular systems, communication between the UE and the gNB is frame-based. During initial access, the UE UL transmissions are not time-aligned with the gNB frame timing due to the roundtrip delay time that is unaccounted for. In order to synchronize the frame timing of both the UE and the gNB—or the UL and DL—the UE sends the PRACH signal which is used by the gNB to make an estimate of the roundtrip delay time. The UE is then informed of the value of the Timing Adjustment (TA) which it needs to apply to its UL transmission for proper alignment of frame timing. In the initial access procedure, the UE therefore transmits a PRACH signal in addition to obtaining the system information from the gNB as is explained below.

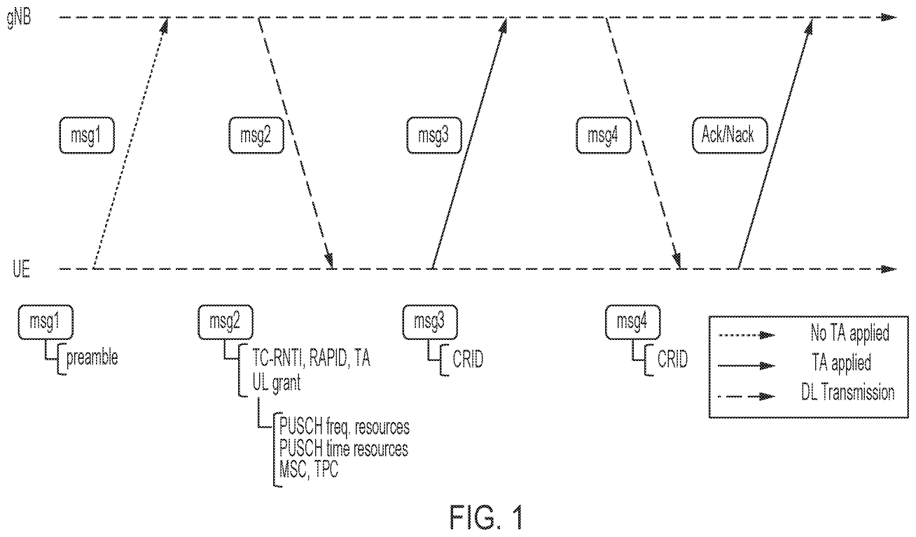

Similar to LTE, the UE performs initial access through the process of Random Access (RA). NR Rel-16 supports the procedure of 4-step RACH which is described here, and illustrated in FIG. 1. Before initializing the random access procedure, the UE receives the broadcasted system information (Master information block (MIB) and System information block (SIB)) from the gNB by means of a Synchronization Signal Block (SSB) transmission. Namely, the UE attempts to receive the broadcast information which provides the UE with the necessary information about retrieving the MIB and SIB. The system information tells the UE about the configuration of the random access procedure. Multiple SSBs are typically broadcast in a periodic manner, where each SSB is sent by the gNB using a different broad transmission beam. The UE then attempts to decode various SSBs, and chooses the best SSB as the one with the highest Reference Signal Received Power (RSRP). This SSB indicates the best broad beam to be used by the gNB for communication with the UE.

The 4-step RACH procedure is as follows. The UE starts by sending a preamble to the gNB. This is referred to as sending msg1 to the gNB. The UE chooses one preamble from a pool of possible preambles. The ID of the preamble chosen by the UE is called RAPID. At this point, multiple UEs could potentially have 4-step RA processes simultaneously initiated. Each UE may be using a preamble with a different RAPID. If the preamble reception by the gNB is successful, the gNB sends msg2 to the UE. msg2 contains the RAPID of the preamble chosen by one (or in case of contention, multiple) UEs, a TA value for the UE with the corresponding RAPID and a UL grant for the transmission of msg3.

The UE proceeds by sending msg3 using the resources indicated in the UL grant. msg3 contains a Contention Resolution ID (CRID) that is provided by higher layers to the physical layer of the UE. The UE applies the value of the TA indicated in msg2 to the transmission of msg3. If multiple UEs have the same RAPID in step 1, these UEs may transmit msg3 containing different CRIDs. The gNB then sends msg4 which contains the CRID of one UE. The UE which has the corresponding CRID proceeds by sending an acknowledgement (ACK) message acknowledging the successful reception of msg4 and the initial access procedure. In the following, these steps are described in more detail.

A first step is the transmission of msg1 (PRACH transmission). The UE initiates the 4-step RACH procedure by sending msg1. During initial access, the UE initiates a Contention-Based RA (CBRA) RACH procedure. The UE starts by picking a preamble from a pool of possible preambles. The pool of preambles is determined based on the selected SSB, and the UE makes a random selection among the preambles in the pool. Depending on the selected SSB, the UE also determines the set of time and frequency resources to use in transmitting the chosen preamble, which is referred to as the PRACH Occasion (RO). Since a valid TA is not necessarily available, the preamble is transmitted with no timing adjustment. The standard specifies a switching time gap between DL transmissions and following UL PRACH transmission.

A second step is the transmission of msg2 (Random Access Response (RAR)). The gNB detects all transmitted preambles, and consequently determines the TA values associated with each transmitted TA. Assuming that each transmitted preamble was chosen by exactly one UE, the gNB then sends a response to each UE where the response includes the RAPID of the intended UE; this response is referred to as Random Access Response (RAR). The gNB transmission, msg2, may include the RAR to one or more UEs. If a UE has a RAR in msg2, then msg2 would also include: 1) the TA value that should be applied by the UE's further transmissions, and 2) a UL grant to the UE which indicates the time/frequency resources to be used by the UE for sending msg3.

After sending msg1, the UE does not know whether it will receive a RAR, nor does it know the exact scheduling of msg2. Instead, it monitors for a certain duration a Type1-PDCCH-Common Search Space (CSS) which is configured for sending msg2. The monitoring period is called the RAR window. During the RAR window, the UE attempts to decode a DCI format 1_0 which would schedule the transmission of msg2.

A third step is the transmission of msg3 (Contention resolution). Upon receiving msg2, a UE which detects its RAPID transmits msg3 according to the UL grant delivered to the UE in msg2. msg3 contains a Contention Resolution ID (CRID), a 39-bit random number generated by the UE (if not configured). Transmission of msg3 is done after applying TA.

A fourth step is the transmission of msg4 (Contention resolution 2). After receiving msg3, possibly from multiple UEs that are in contention, the gNB sends msg4 with the CRID of one UE. All UEs transmitting msg3 would attempt to decode the scheduled msg4. The UE which detects its CRID may consider its RACH procedure as successful and may send an ACK.

When picking a preamble for msg1 transmission, the UE first determines one group from a collection of groups of preambles from which the UE picks a particular preamble. The collection of groups are non-intersecting pools of preambles configured by the gNB inside the cell. When a UE picks a preamble from a particular group, the gNB determines—upon receiving the preamble—which group was picked by the UE. This method of indication is inherited in Release-16 4-step RACH to indicate information about the pathloss level between the UE and gNB, and the potential payload size of msg3. Namely, in Release-16 4-step RACH, the gNB configures two groups of preambles, group A and group B. If configured, then (i) if the pathloss between the UE and the gNB is above a configured threshold, and if the expected payload size of msg3 is above a certain threshold, the UE picks group B, and (ii) otherwise, the UE picks group A.

After the UE sends msg1 and msg3, the UE starts to monitor for the expected reply from the gNB. Specifically, once the last symbol of msg1 (or msg3) is transmitted, the UE starts a monitoring timer, referred to as the monitoring window, at the first following symbol of a CORESET where msg3 (or msg4) scheduling DCIs are expected to be received. The monitoring window duration is Radio Resource Control (RRC) configured at the UE. If a retransmission is needed, the UE receives a DCI 0_0 during the window scheduling a retransmission of msg3. The monitoring window is restarted after each retransmission.

In Coverage Enhancement CE scenarios, the PRACH signal is an UL signal which is degraded in decoding performance due to low SNR. In order to enhance its performance, PRACH repetition may be a viable solution. However, introducing a working PRACH repetition mechanism in Rel-17 which is efficient as well as backward compatible with Rel-16 is a challenge.

As used herein, a “Rel-17 UE” as a UE which is capable of performing one or more of the features described herein and that are not specified in Release 16 of the 5G standard. This terminology is not intended to limit the applicability of the features of this disclosure to any specific release of the 5G (NR) standard or specification.

In some embodiments, PRACH signal transmission may be performed with aggregation, in a manner that is in some respects analogous to the transmission of PUSCHs with repetition. A first set of embodiments may be referred to as Scheme 1. This scheme involves PRACH signal transmission with aggregation, e.g., a Rel-17 UE may send multiple PRACH signals in a sequence of Random Access Channel (RACH) Occasions (ROs), without initiating a Random Access Response (RAR) response monitoring window after each transmission. This is in contrast to Rel-16 PRACH signal repetition, in which a UE initiates a RAR response monitoring window after each PRACH transmission, and only sends a retransmission if the window expires without receiving a corresponding RAR message. A UE may utilize PRACH signal transmission with aggregation in different ways, e.g., as described below for a first embodiment and a second embodiment.

In the first embodiment, a UE may send each of the PRACH transmissions using the same uplink transmit (UL-Tx) beam. This may allow the gNB to improve the received signal to interference and noise ratio (SINR) of the received PRACH signal. Alternatively, the gNB may also use these aggregated PRACH transmissions to perform a form of uplink receive (UL-Rx) beam refinement, in which the gNB attempts to receive each of the PRACH aggregated transmissions using a different receive (Rx) beam. The set of Rx beams used by the gNB may be a set of narrow beams which collectively cover the range of the originally used broad Rx beam. Upon receiving the PRACH aggregated transmissions using different beams, the gNB determines the best one.

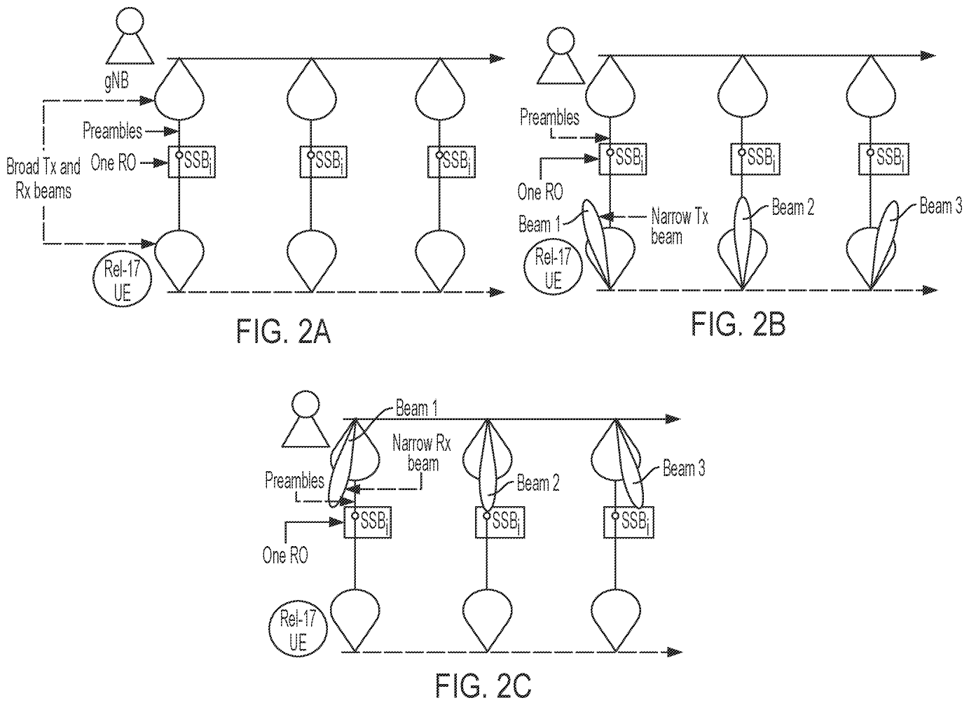

In the second embodiment, the UE may send each of the aggregated PRACH transmissions using a different UL-Tx beam in an attempt to perform UL-Tx beam refinement. The gNB may then indicate to the UE which UL-Tx beam is the best. The set of Tx beams used by the UE may be a set of narrow beams which collectively cover the range of the originally used broad Tx beam. The UE may then be provided with information which aids the UE in determining which Tx beam was best received by the gNB. These embodiments are shown in FIGS. 2A-2C, with FIG. 2A illustrating the use of unchanging beams, FIG. 2B showing the use of different transmit beams, and FIG. 2C showing the use of different receive beams.

In both of these embodiments, sending one PRACH signal which consists of preamble repetitions may be used by the gNB to perform a kind of UL-Rx beam refinement within those preamble repetitions. This is a mechanism which may be employed by the gNB using Rel-16 PRACH transmissions, and may still be employed on top of (i.e., in combination with) the PRACH aggregated transmissions described herein.

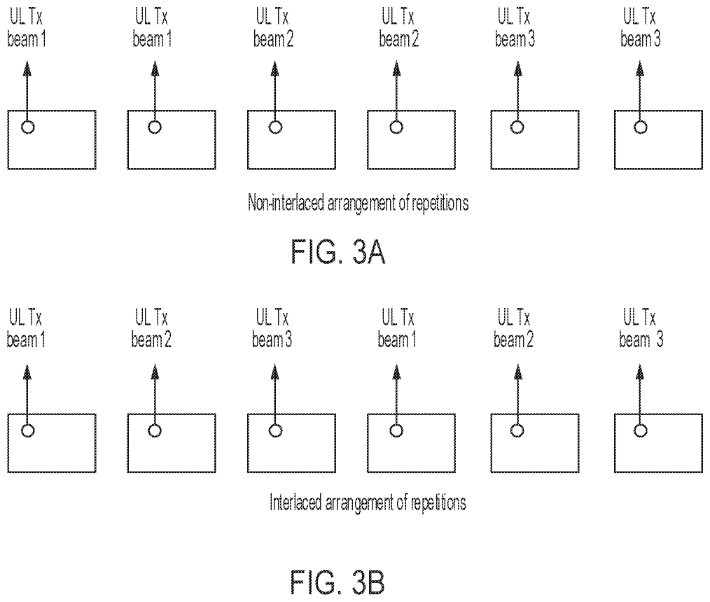

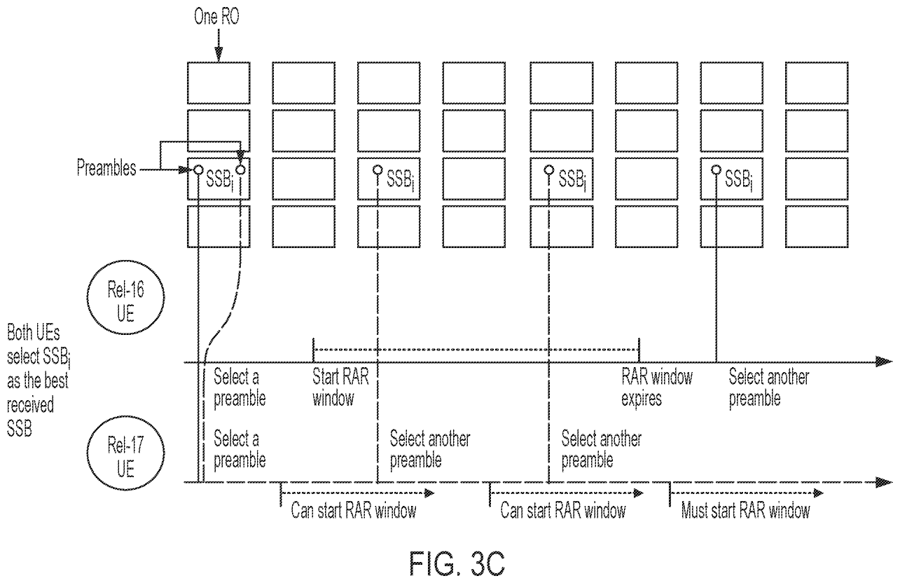

In another mechanism, a UE performing PRACH transmission with aggregation may send some repetitions using the same UL beam while sending other repetitions using different UL beams. Namely, in a set of L aggregations, a UE may send N≤L repetitions using the same UL beam, and then change the UL beam across the different sets of non-overlapping N repetitions. Each set of N repetitions may be consecutive, or alternatively the sets of N repetitions may be interlaced. FIGS. 3A and 3B show examples where L=6 and N=2, with FIG. 3A showing non-interlaced sets and FIG. 3B showing interlaced sets.

In Rel-16 PRACH signal repetition, a UE applies a power ramping behavior which increases the transmission power associated with each PRACH transmission. Rel-17 PRACH transmission with aggregation may have a similar power ramping behavior as in Rel-16. This power ramping behavior may be configured with the same or different power ramping parameters. In other embodiments, Rel-17 PRACH transmission with aggregation may opt to use the same transmission power in all PRACH signals.

In a set of embodiments that may be referred to as Scheme 2, a RACH mechanism for Rel-17 UEs with CE capabilities is performed alongside Rel-16 UEs in the same resources. Namely, the Rel-17 RACH procedure allows UEs to transmit PRACH signals with aggregation in the same resources indicated for a Rel-16 RACH procedure, i.e., the same ROs and preambles. This approach may be beneficial in terms of resource utilization since no separate set of PRACH resources is needed.

With this scheme, a Rel-16 UE follows the legacy RACH procedure by picking a preamble and RO resource corresponding to the Synchronization Signal Block (SSB) index received with the highest reference signal received power (RSRP), and performing a PRACH transmission (of Msg1) in that RO. After the PRACH transmission, the UE starts a RAR response monitoring window which starts at the first Control Resource Set (CORESET) symbol after the PRACH transmission. The UE does not resort to PRACH retransmission unless the RAR window expires and a corresponding RAR is not received. Concurrently, a Rel-17 UE uses the same RO and preamble determination scheme as in the legacy RACH procedure. However, the Rel-17 UE sends PRACH signal repetitions in later ROs which are associated with the same SSB; the UE is not required to start a RAR window until it sends the last configured retransmission. Rel-16 and Rel-17 UE behaviors in this scheme are shown in FIG. 3C. A Rel-17 UE has the option to start a RAR window after any of the PRACH transmissions in the PRACH aggregation. This may facilitate an early termination of the RACH procedure as well as the procedure of UL-Tx beam refinement as described below.

When a Rel-17 UE determines the sequence of PRACH sequences for transmissions, a UE may follow a certain procedure for selecting preambles out of the available set of ROs. One mechanism is to let the UE targeting the transmission of L PRACH repetitions select preambles from ROs associated with the selected SSB index. More generally, a UE may select preambles from various ROs according to a particular selection procedure. This procedure may select preambles from ROs associated with the same SSB index or other ROs. This procedure may also be deterministic (i.e., a UE wishing to perform L PRACH transmissions selects a deterministic set of L preambles) or random (i.e., a UE wishing to perform L PRACH transmissions may have randomness in the procedure of selecting L preambles).

The following nomenclature is used to provide a general description of the preamble selection procedure. The ith preamble in a set of L preambles may be labelled by rᵢ, the label of the RO carrying the PRACH transmission, and pᵢ, the label of the preamble sequence used in the pool of available preamble sequences in the RO. Similar to the legacy operation, it may be the case that the UE determines the set of L preambles based on an SSB index, labelled by s, which is determined by the UE during the phase of SSB detection that precedes the PRACH transmission phase. For example, the SSB index s may be selected as the one with the highest detected RSRP value.

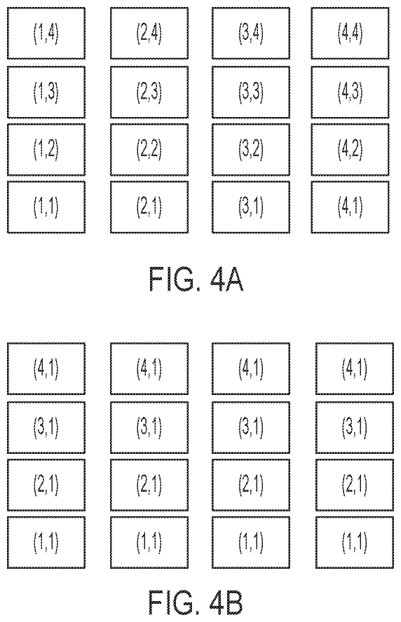

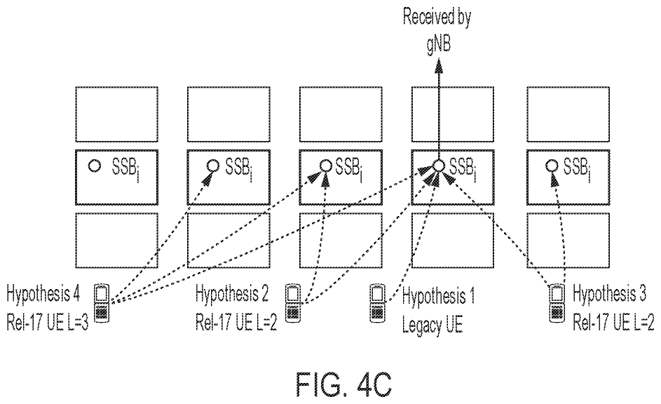

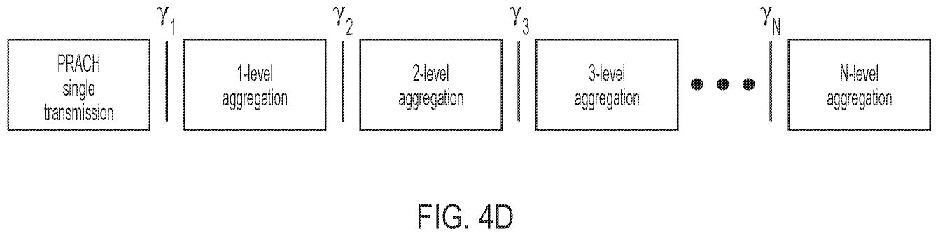

The set of RACH resources provided by the RACH configuration parameters consists of a set of ROs each of which is associated with a particular SSB index. An RO label r=(r^{s}, r^{t}) may therefore consist of two indices: the SSB index r^{s} associated with the RO, and the relative RO index r^{t} among the set of ROs associated with the SSB index r^{s}. For example, if there are 4 ROs associated with the SSB index s, they would have the labels (s, 1), (s, 2), (s, 3), (s, 4). Conversely, if for example there are 4 available SSB indices, the set of t^{th} ROs associated with each of the SSB indices is (1, t), (2, t), (3, t), (4, t). The time and frequency resource configuration of the ROs may lead to different arrangements of the ROs. For example, in an ordering of the ROs in a frequency-first manner, the ROs may be arranged by cycling through r^{t} index first (FIG. 4A) or cycling through r^{s} index first (FIG. 4B). The aforementioned arrangements of ROs are not necessarily the explicit configuration of PRACH resources as provided via RRC configurations for the UE. In fact, these arrangements are most likely the implicit result of certain PRACH configurations. For example, the arrangement in FIG. 4A may be the result of having 4 SSB indices, 4 ROs per SSB index in one association period, and that PRACH configuration period consists of 4 sets of ROs which are time division multiplexed (TDMed), and there are 4 FDMed ROs within one set; FIG. 4A shows one association period. Differently, FIG. 4B shows an arrangement which is the result of having 4 SSB indices, 1 RO per SSB index in one association period, and that one PRACH configuration period consists of 4 frequency division multiplexed (FDMed) ROs; FIG. 4B shows four association periods.

Selecting the ith preamble in a set of L preambles consists of selecting rᵢ, the label for the RO to use in transmitting the ith preamble, and pᵢ, the used preamble index in that RO. There may be different rules, e.g., five rules referred to herein as R1 through R5, for selecting rᵢ for i∈{1, . . . , L}.

R1: a UE may select rᵢ in any order. This corresponds to a selection of L preambles with no structure; this may be a simple mechanism but may not aid in gNB decoding operation.

R2: a UE may select rᵢ such that rᵢ^{s}=s and any valid value of r₁^{t}. This is a more structured version of R1 in which all selected ROs are associated with the same SSB index.

R2a: a UE may select r₁ such that r₁^{s}=s and r₁^{t}=1, and remaining rᵢ are selected such that rᵢ^{s}=s and rᵢ^{t} is any valid value. This forces the UE to initiate preamble transmission in the first available RO associated with the SSB index; this may have an impact on the decoding complexity for the gNB (as discussed in further detail below).

R3: another variation to R2a is to add more structure to the selection of the rᵢ, i>1, i.e., rᵢ^{t}=rᵢ₋₁^{t}+X. This may provide high structure in the selection procedure; the value of X may be 1 or other values. When R3 is used, each PRACH transmission, of a set of consecutive PRACH transmissions sharing an SSB index, may have an RO index greater than the RO index of the previous PRACH transmission by a set integer (the integer X). X=1 allows a UE to use L consecutive ROs associated with the SSB index. The set integer (X) may be RRC configured, or configured by a System Information Block, or specified in the 5G standard and programmed into the UE (and configured at startup of the UE).

R4: another variation to R3 is not to associate rᵢ, i>1 with the same SSB index, i.e., rᵢ^{s}≠s. In this case, other methods may be used for selecting rᵢ^{s}. One method is to select the L most recent ROs regardless of their SSB index association; this may be helpful to reduce latency in transmitting the preambles.

R5: another variation to R4 in the method used for selecting rᵢ^{s}, i>1 is to select the L most recent ROs regardless of their SSB index association, while at the same time avoiding having ROs with certain properties, e.g., FDMed ROs, or ROs without sufficient timeline in-between. This may help reduce burden on the UE operation.

There may be different rules, e.g., two rules referred to herein as P1 and P2, for selecting pᵢ for i∈{1, . . . , L}.

P1: pᵢ may be randomly selected out of the pool of available preambles in the ith RO—this may be a simple mechanism to describe the operation, although it lacks any structure in the set of selected preambles and therefore may make the gNB decoding operation more difficult.

P2: pᵢ may be determined as a function of the preamble selected in the previous transmission, e.g., pᵢ=pᵢ₋₁+P for some integer value P, while selecting p₁ randomly from the first RO; this gives more structure to the set of selected preambles. The integer P may be a set integer, e.g., it may be available (e.g., known) to both the UE and the gNB at the time the preamble is transmitted. One possibility is to have P=0, in which case selected preambles are the same for all transmissions.

The following provides some examples of how the procedure for selecting the L preambles may be performed. In the above determination rules, there may be a limitation on the selected set of L PRACH transmissions that they must occur within one SSB-RO association period. That is, for N SSBs, all L preambles must be selected within one set of ROs where the N SSBs are completely mapped at least once. This has the benefit of maintaining the legacy nature of the RACH procedure in which any UE performing RACH operation is guaranteed to complete msg1 transmission within the duration of the association period, which would consequently guarantee certain latency levels for the RACH procedure as well as limit the UE complexity.

When considering the transmission of L PRACH transmissions by Rel-17 UEs, a gNB is not necessarily aware of the identity of the UE performing PRACH transmission and whether this is a legacy UE or a Rel-17 UE. Assuming that the maximum candidate value for number of repetitions is M, then the gNB also is not aware of the exact value of L≤M which the UE has selected as a number of PRACH transmissions. Moreover, in the case of a UE transmitting PRACH repetitions using the same beam, the gNB may utilize these transmissions for a joint decoding operation which may increase the decodability of the PRACH transmission. Therefore, the gNB has two options when decoding PRACH transmissions. First, a gNB may treat each PRACH transmission independently as if it is originated from a legacy UE. Second, a for a given PRACH transmission, a gNB may make an assumption that a Rel-17 UE performed that transmission, and consequently use this transmission along with the corresponding potential L−1 other repetitions to perform joint decoding.

Option 1 provides a simple decoding operation for the gNB with limited performance, while the second operation may provide better decoding performance at the expense of higher decoding complexity. The main reason behind this complexity is the fact that a gNB has to consider different hypotheses for the potential sequence of L PRACH transmissions when decoding one PRACH transmission.

For example, the preamble selection operation which follows R3 with X=1 (i.e., the L-most recent ROs associated with the SSB index are selected) and P2 with P=0 (i.e., the same preamble index is used in all ROs). Given a selected SSB index i, when a gNB receives a preamble p in an RO r, there are different hypotheses as to which UE has generated the preamble. For example, it may be (i) a UE performing one PRACH transmission (e.g., Rel-16 UE), (ii) a UE performing L=2 PRACH transmissions, and this preamble corresponds to either the first or the second of those transmissions, or (iii) a UE performing L=3 PRACH transmissions (with the present preamble corresponding to either the first or the second or the third of those transmissions). Analogous hypotheses exist for L>3. FIG. 4C shows a sample of the hypotheses which a gNB makes when decoding a received PRACH transmission under the configuration that Rel-17 UEs may attempt PRACH transmissions with L aggregations.

With no constraints, the number of potential hypotheses for UEs which could be performing preamble transmission on any given RO is M. The decoding procedure of the gNB may be heavily affected by the number of potential hypotheses as to which case this preamble transmission corresponds to. In order to assess the decoding complexity of the gNB, the following distinction may be made in the implementation of the decoding operation at the gNB side.

Joint-decoding approach (JD): in this implementation, the gNB may jointly use the preambles transmitted in all repetitions in the decoding procedure. In this approach, the gNB may determine or hypothesize which set of preambles belong to one set of repetitions so that the decoding operation may be based on this set of preambles.

Repeated-decoding approach (RD): in this implementation, the gNB successively and independently attempts to decode each preamble transmission, consequently declaring that the preamble transmission is successful if any of the repetitions is successfully received. In this approach, a gNB may mostly require to determine or hypothesize whether a preamble transmission is made from a legacy UE or a Rel-17 UE performing repetitions.

Depending on the implementation, certain measures may be taken to limit the decoding complexity of the gNB. The following are three exemplary restrictions that may be put on which preambles a UE targeting L PRACH repetitions may use.

In a first restriction, a UE may be restricted to transmit a set of L preambles in only a subset of the available ROs for legacy preamble transmission. For RD, this limits the number of hypotheses made by the gNB to only one (legacy) in the ROs which only legacy UEs are allowed to use. More specifically, a UE may be instructed to only use a set of N′<N ROs among the N available ROs (i.e., to only use a proper subset of the N available ROs) for sending the first preamble in a set of L preambles, and then the following preambles may be sent in consecutive following ROs (e.g., R3 with X=1). The proper subset (i.e., the set of N′ ROs may be a set proper subset, i.e., it may be a proper subset that is available to (e.g., known) to both the UE and the gNB at the time of the transmission of the preambles. The set of N′ ROs may be RRC configured. The set of N′ ROs may be uniformly distributed among the N ROs. When

$$M \leq ⌊ \frac{N}{{N}^{′}} ⌋ ,$$

the maximum number of hypotheses made by a RD gNB would be 2 in

$${N}^{′} ( ⌊ \frac{N}{{N}^{′}} ⌋ - M ) and 1 in M - {N}^{′} ( ⌊ \frac{N}{{N}^{′}} ⌋ - M ) .$$

In a second restriction, a UE may be instructed to send only the first preamble transmission of a set of L repetitions on the first RO in the association period that corresponds to the selected SSB index. With this approach, for JD, the number of hypotheses assumed by the gNB when receiving a preamble in an RO depends on the relative RO location with the association period. For example, if the RO is the ith RO mapped to the target SSB index within the association period, the number of potential hypotheses for UEs which could be performing this preamble transmission is M−i+1. This means that the first RO in the association period may require a gNB to make L hypotheses, while the gNB makes only 1 for the last RO.

In a third restriction, a UE may be instructed to send the first preamble in a set of L PRACH repetitions in an RO location which is dependent on the number of repetitions L. For example, assuming the existence of N ROs in the association period corresponding to the selected SSB index, the first preamble transmission in a set of M/2 or fewer repetitions may be started either at the first RO or the (N/2)^{th} RO in the association period, while the first preamble transmission in a set of more than M/2 repetitions may be started only at the first RO. This provides more flexibility for the UE to start its transmissions at the expense of more decoding complexity at the gNB. For JD, the number of hypotheses made by a gNB at each RO may be less than allowing arbitrary starting locations for L preamble transmissions. A generalization of the third restriction is to provide RO indices for the starting preamble transmissions corresponding to different values of L in a finer granularity than L/2. The above-described restrictions may be re-used while using the association pattern period instead of the association period.

In Scheme 2, a Rel-17 UE only sends PRACH signal with aggregations if the UE is in a Coverage Enhancement (CE) scenario. Namely, a UE makes such a decision based on the received RSRP of the best SSB index which it has selected. Such a decision may be made in different ways. For example, in a first embodiment, a UE may have a threshold γ, and the UE may use Rel-17 PRACH signal aggregations if the received RSRP of the best SSB is smaller than or equal to γ; otherwise it may use the Rel-16 approach.

In a second embodiment, a UE may have multiple thresholds γ₁≥γ₂≥γ₃≥ . . . ≥γ_{N}. If the received RSRP of the best SSB is larger than γ₁ then it uses Rel-16 PRACH transmission. If the received RSRP of the best SSB is larger than γ₂ and smaller than or equal to γ₁, then it uses Rel-17 PRACH signal aggregation with a certain number of retransmissions. If the received RSRP of the best SSB is larger than γ₃ and smaller than or equal to γ₂, then it uses Rel-17 PRACH signal aggregation with a larger number of retransmissions, and so on. FIG. 4D illustrates this process for determining PRACH aggregation level.

Configuring Rel-17 UEs with PRACH signal aggregation to perform their transmissions in the same resources as Rel-16 UEs may be considered as an unfair behavior, in the sense, for example, that such a behavior may lead to a higher collision rate for Rel-16 UEs, which increases latency in the initial access procedure. However, counterarguments may be made regarding these concerns. For example, a UE only performs PRACH signal aggregation if it is in a CE scenario. In this case, a single PRACH transmission experiences poor channel conditions and therefore is typically received with a low SNR. If this PRACH transmission collides with another PRACH signal from a Rel-16 UE, its effect is likely to amount to only limited interference levels, and therefore may not significantly impede the Rel-16 UE initial access procedure. Moreover, a Rel-17 UE in a CE situation may be thought as one in a naturally disadvantageous situation, since its PRACH transmissions are likely to be missed or not decoded. As such, the use of use of PRACH signal aggregation may be considered to be a mechanism available to a Rel-17 UE for compensating for a disadvantage, e.g., a poor SNR.

In this setting, a gNB receives PRACH signals without being able to associate these signals with either (i) Rel-16 UEs with single PRACH transmissions or (ii) Rel-17 UEs performing PRACH transmission with aggregation. In other words, from a gNB perspective, one Rel-17 UE performing PRACH transmission with, say, 5-level aggregation may be considered as 5 virtual Rel-16 UEs. This situation, if not appropriately handled, may lead to a misconfiguration of a Rel-17 UE which may receive various RAR messages each with different configurations and TC-RNTI.

One way to handle such a situation may be to configure the Rel-17 UE performing PRACH transmission with aggregation to respond to at most one RAR message corresponding to the preamble IDs of its PRACH transmissions. This allows the gNB to automatically rectify the issue of dealing with multiple virtual UEs as soon as the gNB receives at most one Msg3 corresponding to at most one of the set of virtual UEs. As used herein, a “preamble ID” refers to a complete identification of the preamble sequence used.

Alternatively, a Rel-17 UE may respond to more than one RAR message corresponding to the preamble IDs of its PRACH transmissions, but indicate in these RAR response messages which preamble IDs are those that are part of its PRACH transmissions. Upon decoding a RAR response message, the gNB is then made aware of the preamble IDs used by the same Rel-17 UE and may then act accordingly.

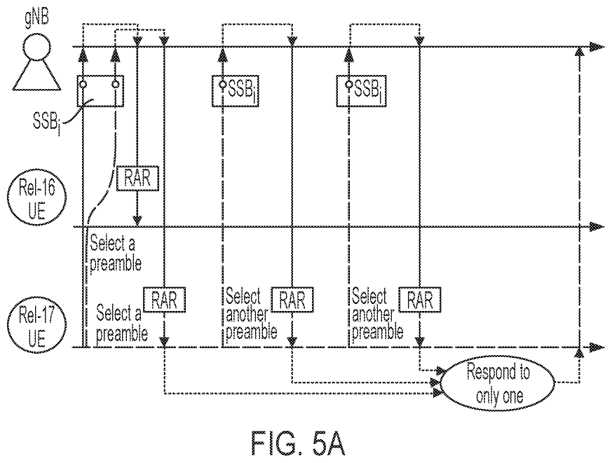

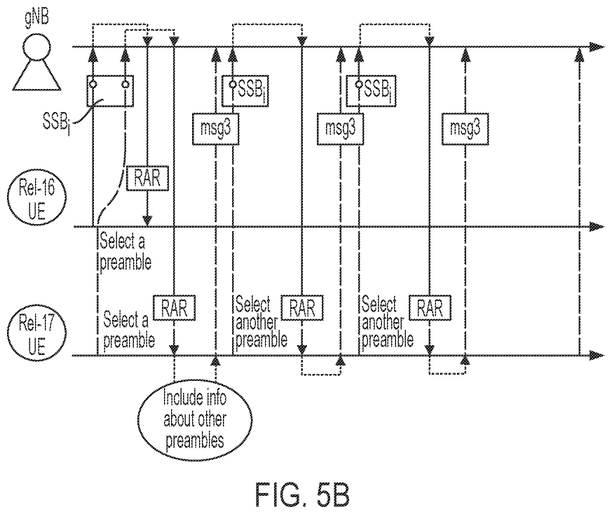

FIGS. 5A and 5B show examples of communications between the gNB and both types of UE when PRACH transmission with aggregation is enabled. A Rel-17 UE performing PRACH aggregated transmission may start a RAR window only after the transmission of the last PRACH repetition. The UE may use a different RAR window configuration than the one configured for a Rel-16 UE sending one PRACH transmission. In this case, the gNB may be aware of the potential PRACH aggregation sequences and send RAR messages in the corresponding RAR windows that could be initiated by potential Rel-17 UEs performing PRACH aggregations. The UE may use the same RAR window configuration as the one configured for Rel-16. In this case, the gNB may correspond to the potential Rel-17 UE with the same RAR message as it does for a Rel-16 UE.

In this communication, a UE may send a reply to one RAR message, multiple RAR messages, or all RAR messages. The aforementioned operation of the gNB may be argued to be resource-wasteful, because, e.g., a gNB may respond to receiving multiple PRACH signals from a Rel-17 UE sending PRACH with aggregation by sending multiple RAR messages. However, such an event is not likely given that only a Rel-17 UE in a CE situation will perform PRACH transmission with aggregation, due to the expected low SNR of the received PRACH signal. If multiple RAR messages are indeed received by the UE, a UE may then select the one received with the highest RSRP to respond to. This may be particularly helpful when the PRACH signals are transmitted by the UE using different and narrower beams as in the second embodiment described above and illustrated in FIGS. 2A-2C. This additional benefit of implementing a form of UL beam refinement comes at the cost of sending multiple RAR messages. A UE may utilize the transmission of multiple RAR response messages to inform the gNB of information that may be useful for a beam refinement operation. For example, a UE may indicate to the UE the received signal strength associated with each RAR message.

When a Rel-17 UE sends a PRACH signal with L-level aggregation, it is required to at least start a RAR response monitoring window after the transmission of the Lth PRACH signal. However, a UE may also start a RAR response monitoring window at earlier points in time after transmitting the first PRACH signal. If the UE operates in this way, a UE may receive a RAR response message corresponding to one of the transmitted PRACH signals before sending all L PRACH signals. Assuming that the UE receives a RAR message before sending the j^{th} PRACH signal (where ‘before’, in this context means that the time between the received RAR response message and the j^{th} signal is more than the time required to process the received message and stop transmitting the PRACH signal), the UE may behave as follows.

In a first behavior, referred to as Behavior-1, the UE may cease the transmission of the j^{th} PRACH signal and all subsequent PRACH signals. This may be a viable option if PRACH signals within the PRACH aggregation are being transmitted by the UE using the same UL beam. Therefore, receiving a RAR message indicates that PRACH transmission was successful and there is no longer a need for repetitions.

In a second behavior, referred to as Behavior-2, the UE may continue the transmission of the jth PRACH signal and all subsequent PRACH signals as if a RAR message is not yet received.

In a third behavior, referred to as Behavior-3, the UE may continue transmission of the j^{th} PRACH signal and all subsequent PRACH signals. To make use of those transmissions, the gNB is required to identify the set of PRACH signals which belongs to the PRACH aggregation. Therefore, in this option, the UE may report to the gNB the IDs of the upcoming PRACH transmissions. This may be useful in two ways, as follows.

In a first variant of the third behavior, referred to as Behavior-3a, if PRACH aggregations were transmitted using different UL-Tx beam in an attempt to identify the best narrow UL beam, then continuing such transmission may serve the purpose of UL beam refinement. The gNB may send a RAR-like message after the last PRACH transmission indicating which preamble was best received. Rel-16 PRACH transmission includes PRACH formats which include sequence repetitions. These repetitions may be used by the gNB to perform a UL-Rx beam refinement procedure. In this case, Behavior-3a may perform both UL-Tx and UL-Rx beam refinement.

In a second variant of the third behavior, referred to as Behavior-3b, the UE may send each PRACH aggregation using the same UL beam. This may give rise to the option that the gNB may perform a UL-Rx beam refinement procedure: the UE may transmit the remaining PRACH signals using the same best UL-Tx beam, and the gNB may use this UL-Tx beam to search for the best UL-Rx narrow beam.

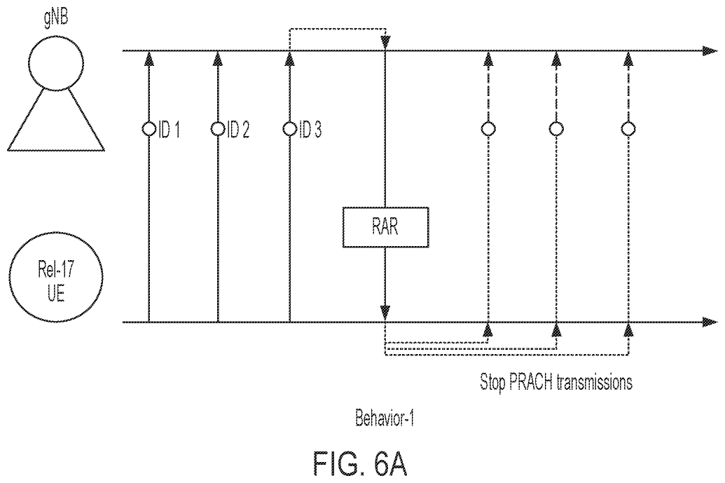

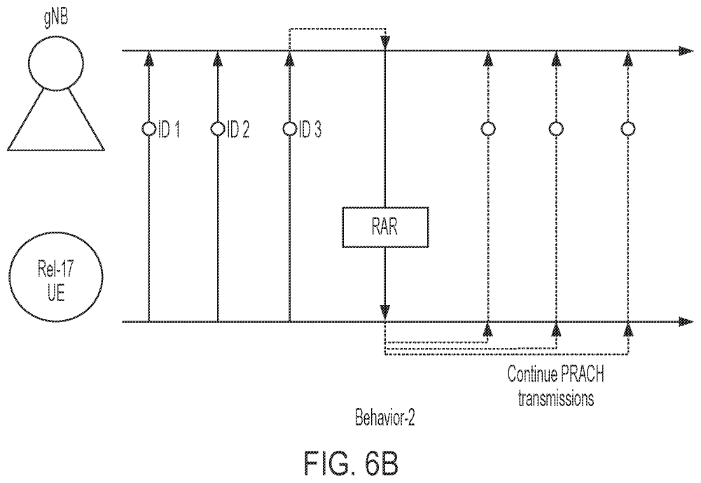

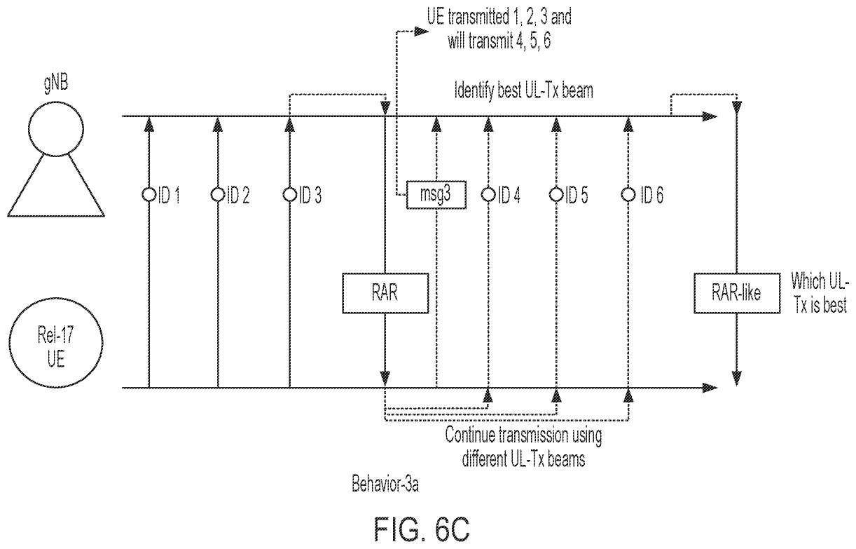

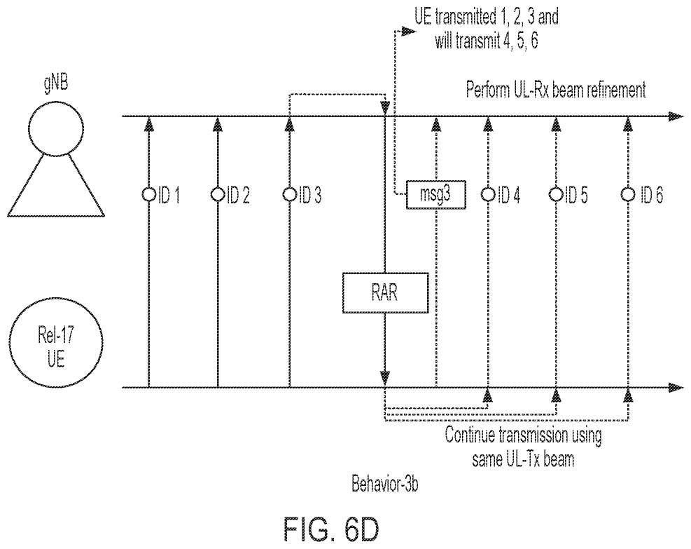

FIGS. 6A-6D show various possibilities for the behavior of a Rel-17 UE with respect to remaining PRACH signals after receiving a RAR message. When providing an identification of the ROs used in PRACH aggregation to the gNB via a particular Msg3, there may be multiple options. One option is that the identification of each RO may be in terms of the absolute time and frequency locations of the RO. Another option is that the identification may be in terms of time and frequency offsets in relation to the RO associated with the transmitted Msg3. For example, an RO indicated in the PRACH aggregation may be in terms of slots (time division multiplexed (TDMed)) ROs before or after the particular RO and (frequency division multiplexed (FDMed)) ROs above and below the particular RO. This approach may be useful in reducing the overhead of indicating absolute time and frequency values of multiple ROs.

When a UE initiates a RAR monitoring window after the transmission of a PRACH other than the last one in the L aggregations, it is possible that the RAR monitoring window may overlap with time durations which include ROs where the UE is to send the following PRACH repetition. In this case, the UE may not be able to concurrently monitor for the DL RAR message and perform the UL PRACH repetition. In this case, certain priority rules (such as the three priority rules described below) may be useful. In a first priority rule, the UE may prioritize the transmission of the PRACH repetition over the monitoring for the RAR message. When the UE is expected to prioritize the transmission of the PRACH repetition, a timeline may be established between the time for transmitting the PRACH signal and the time for reception or monitoring of the PDCCH corresponding to the RAR message. Namely, a UE is not expected to receive a PDCCH corresponding to the RAR message after a timeline measured with respect to the transmission of the PRACH repetition. The timeline may be established from the end of the last symbol which carries the PRACH repetition or the end of the last symbol for the RO where the PRACH will be transmitted. The duration of the timeline may be equal to the time needed for switching from UL transmission to DL reception: that duration T_{switch} may be equal to the same switching time value defined in the legacy NR specification, or some other value. The time may also be increased to accommodate the time needed to complete the transmission of the PRACH since the timeline is established from the beginning of the PRACH transmission. When the statement “the time for reception/monitoring of the PDCCH corresponding to the RAR message” is mentioned (in the standard), the time may be a) the time of the first symbol carrying the PDCCH, or b) the time for the first symbol of the CORESET carrying the PDCCH.

An additional timeline may be established prior to the transmission of the PRACH repetition. Namely, since a PRACH transmission is prioritized over the reception of a PDCCH corresponding to a RAR message, sufficient time may be reserved before the starting time for PRACH transmission to allow a UE to switch from DL reception to UL transmission. More specifically, a timeline may be established from a time before the starting time of a PRACH transmission with a duration T_{switch} (or other values as mentioned above) to the starting time of a PRACH transmission. In this timeline, a UE does not expect to receive a PDCCH corresponding to a RAR message. The starting time of a PRACH transmission may be the time of the first symbol which carries the PRACH repetition or the first symbol for the RO where the PRACH will be transmitted.

When a gNB attempts to schedule a RAR message corresponding to the successful reception of a PRACH transmission, it does not know beforehand whether this PRACH transmission is made by a legacy UE or a Rel-17 UE performing PRACH repetitions. If the UE is a Rel-17 UE, the RAR message must be scheduled in adherence to the aforementioned timeline, while this is not necessary for a legacy UE. Therefore, a gNB may take a conservative approach and adhere to the timeline in anticipation that the UE may be a Rel-17 UE performing PRACH repetitions. This conservative approach may have an indirect effect on legacy UE operation since a portion of the RAR window which does not satisfy the timeline with respect to PRACH repetition occasions may not be used by the gNB. Differently, a gNB may adopt an aggressive approach and not adhere to the timeline. Since a UE is not expected to receive this RAR, this behavior is then effectively identical to not sending this RAR message for Rel-17 UEs. This reserves the operation and potential performance impact on legacy operation, at the expense of not using earlier RAR transmissions for sending msg2 to Rel-17 UEs.

In a second priority rule, the mechanism for determining the ROs for the PRACH repetition may establish a set of potential ROs which contain more than one available RO for the transmission of one PRACH repetition. For example, the transmission of the i^{th} PRACH repetition may be made in any RO within the set RO, which may contain more than one RO. In this case, skipping the use of one or more ROs in favor of monitoring for the RAR message may not entirely skip the possibility for the UE to send the PRACH repetition. In the spirit of this observation, the UE may prioritize monitoring for the RAR message over the transmission of overlapping ROs as long as there is at least one potential RO for sending the PRACH repetition. In a third priority rule, a UE may always prioritize the monitoring for the RAR message.

Depending on UE behavior, a Rel-17 UE may be required to send the gNB some additional information after receiving a RAR message, e.g., it may be required to transmit to the gNB the IDs of the preambles that were and will be transmitted by the UE during the PRACH aggregation. This information may be included in the corresponding Msg3. For example, (i) the information may be added in the payload of the Msg3, or (ii) the information may be included in the MAC header of the PUSCH corresponding to the Msg3. The latter approach may be useful to aid in the decoding of Msg3 if the MAC header was successfully decoded but the PUSCH payload was not. In this case, the information extracted from the MAC header may allow the gNB to receive repetitions of Msg3 as discussed below, in the context of message combining.

In another mechanism, a Rel-17 UE may select one preamble to use in a first PRACH transmission among the PRACH aggregations, and then the UE is restricted to using the same preamble sequence in all upcoming PRACH repetitions. Using this mechanism, the gNB is able to identify the sequence of PRACH aggregation transmissions once the gNB identifies the preamble sequence used by the Rel-17 UE. This reduces the overhead of conveying the preamble ID information of all PRACH transmissions performed by the Rel-17 UE, since only the RO locations are indicated in the Msg3 payload and MAC header. Namely, a reduction of L*log₂ 64=6L bits may be attained for an L-level PRACH aggregation and assuming 64 preambles per RO.

For each Msg2 (RAR message) scheduled by the gNB, there is a corresponding resource allocation for a PUSCH corresponding to the expected Msg3 (RAR response message) by the UE. A UE with Rel-17 PRACH aggregation is required to respond to at least one Msg2 by sending the corresponding Msg3. Then, the resource allocations for all remaining hypothetical Msg3s remain to be handled.

One option, referred to as resource reservations, may be used, as follows. The resource allocations may be reserved in anticipation of the upcoming Msg3. This is a direct consequence of the gNB behavior which treats all PRACH transmissions as coming from different virtual UEs. This is the simplest behavior although it incurs resource waste. This would be a direct consequence of UE Behavior-1 and Behavior-2.

Another option, referred to as resource release, may be used, as follows. The reservation of such resources may be canceled upon determining that the corresponding PRACH transmissions belong to the same UE. This requires that the gNB acquires such information, and is therefore a valid option for UE Behavior-3. This may be done by letting the Rel-17 UE include in Msg3 all the preamble IDs transmitted by the UE. When the gNB receives this Msg3, it knows which other Msg3 reservations correspond to PRACH aggregations and may thus release their resources.

Another option, referred to as message combining, may be used, as follows. The UE may be allowed to utilize the extra resources to perform Msg3 repetitions or aggregations. This also requires that the gNB is informed that these resource allocations belong to PRACH transmissions within one PRACH aggregation. The same indication mechanism as may be used in resource release may be used here. The Msg3 repetitions may be used by the gNB to enhance the reception of the RAR message response. This option is only valid if the gNB is able to retrieve the information regarding the preamble IDs in the PRACH aggregation of the UE, while still being unable to decode the payload of Msg3; this may be the situation if the UE includes the preamble ID information in the MAC header of Msg2.

Both resource reservations and resource release may require a certain timeline to be feasible. Namely, a Msg2 containing the necessary information must be received sufficiently far in advance of the following Msg3 for the resources to be released or combined. For example, any Msg3 resources occurring after the reception of Msg2 but before enough time has elapsed to process the Msg2 are automatically handled according to the method of resource reservations. Also, any Msg3 transmission informing the gNB of (i) the UE behavior with respect to PRACH aggregated transmissions and of (ii) the associated Msg3 resources must be decoded by the gNB and its information processed by the gNB.

The embodiment of FIG. 5A may involve the following provisions in the standard. First, a Rel-17 UE is allowed to transmit PRACH signals with L-level aggregation (i.e., without employing a RAR response monitoring window after each PRACH transmission) if the UE passes the CE condition corresponding to this particular aggregation level. Second, a Rel-17 UE transmission of PRACH signal with aggregation may be employed with or without a power ramping behavior. Third, upon sending a PRACH signal with aggregation, a Rel-17 UE responds to at most one correspond RAR message. A UE may be configured to reply to the first received RAR message, or a UE may be configured to wait for possible multiple RAR messages. In the latter case, it may select the RAR message to which it responds based on some criteria. An example of such a criterion is the RSRP level of each RAR message. Another example is an indicator added by the gNB in the RAR message which indicates the RSRP level of the received PRACH signal.

In a set of embodiments that may be referred to as Scheme 3, a RACH mechanism for Rel-17 UEs with CE capabilities may be performed alongside Rel-16 UEs in separate resources. Namely, the Rel-17 RACH procedure allows UEs to transmit PRACH signals with aggregation in different resources than the one used for a Rel-16 RACH procedure. The set of separate resources for Rel-17 UEs may consist of separate ROs or separate preambles within the same ROs, or a combination of both. With such a separation of resources, a gNB is able to determine the existence of Rel-17 UEs performing a RACH procedure with PRACH aggregation and handle the transmissions from the UEs accordingly.

In this scheme, a Rel-17 UE follows the legacy RACH procedure by picking a preamble and RO resource corresponding to the SSB index received with the highest RSRP. However, the UE picks such resources in the set of resources configured for a Rel-17 RACH procedure with PRACH aggregation. After transmission, a UE may start a RAR response monitoring window after the last PRACH repetition, after each PRACH repetition, or proceed according to other options. In any configuration, a gNB is aware of the UE behavior in terms of the RAR response monitoring window and acts accordingly.

Although a Rel-17 UE may be performing PRACH transmission with L aggregations using dedicated resources, it may still have the possibility of starting those L aggregations at any given resource which is appropriate for sending the first PRACH transmission. This may affect the complexity of the decoding operation at the gNB as discussed above in Scheme 2. Therefore, the solutions mentioned in that discussion above are also applicable in this case.

In this scheme, a Rel-17 UE only sends a PRACH signal with aggregations if the UE is in CE scenario. A UE makes such a decision based on the received RSRP of the best SSB index using one or various thresholds as discussed in Scheme 2.

When a Rel-17 UE sends PRACH signal with L-level aggregation, it is required to at least start a RAR response monitoring window after the transmission of the Lth PRACH signal. However, a UE may also start a RAR response monitoring window at earlier points in time after transmitting the 1st PRACH signal. If the UE operates in this way, the gNB may provide the UE with a RAR response message corresponding to one of the transmitted PRACH signals before the UE sends all L PRACH signals. This gives the UE the ability to finish the RACH procedure at an earlier time with reduced latency, but this comes at the expense of higher complexity in monitoring for multiple RAR instances. Upon receiving a RAR message, the UE has the same options (Behavior-1, Behavior-2 and Behavior-3) regarding the transmission of the remaining PRACH signals.

Depending on UE behavior, a Rel-17 UE may be required to send the gNB some additional information after receiving a RAR message, e.g., the IDs of the preambles that were and will be transmitted by the UE during the PRACH aggregation. This information may be included in the corresponding Msg3. For example, (i) the information may be added in the payload of Msg3, or (ii) the information may be included in the MAC header of the PUSCH corresponding to Msg3. The latter may be useful to aid in the decoding of Msg3 if the MAC header was successfully decoded but the PUSCH payload was not. In this case, the information extracted from the MAC header may allow the gNB to receive repetitions of Msg3 as discussed above, in the context of message combining.

Alternatively, a Rel-17 UE may tie the preamble sequences that are used in PRACH aggregated transmission. Specifically, a Rel-17 UE may select one preamble to use in a first PRACH transmission among the PRACH aggregations, and then the UE is restricted to using the same preamble sequence in all upcoming PRACH repetitions. Using this mechanism, the gNB is able to identify the sequence of PRACH aggregation transmissions once the gNB identifies the preamble sequence used by the Rel-17 UE. Because the RO configuration for PRACH aggregated transmission is a separate configuration from Rel-16, there is a natural tying behavior in the ROs being used for PRACH aggregated transmission. Therefore, when preamble sequences are also tied, this allows the gNB to uniquely determine the sequence of PRACH preambles and ROs in a PRACH aggregation by detecting the first preamble sequence and without any additional information from the UE.

When the UE transmits multiple PRACHs, they may be associated with different SSBs or the same SSB as described in this disclosure or by using any other method. In this case, it is important to determine which beam should be applied for the subsequent transmissions or receptions in the initial access procedures, Msg2, Msg3, Msg4 and the PUCCH carrying Hybrid Automatic Repeat Request (HARM) information for Msg4.

Beam handling for Msg2 reception may be performed as follows. If the transmitted PRACH repetitions are associated with the same SSB, e.g., PRACHs are transmitted in ROs associated with the same SSB, the UE may assume that Msg2, e.g., the Msg2-PDCCH or the Msg2-PDSCH, are transmitted using the same beam as the one used for transmitting the SSB associated with PRACH repetitions. In other words, the UE may assume that the beam used for Msg2 (DM-RS of Msg2-PDCCH or Msg2-PDSCH) has the same Quasi-Colocation (QCL) properties for the SSB and Channel State Information Reference Signal (CSI-RS) associated with any of the PRACH repetitions.

If the transmitted PRACH repetitions are associated with different SSBs, e.g., PRACHs are transmitted in ROs associated with the different SSBs, any of the following approaches may be used to assist the UE in determining which beam should be assumed for the reception of Msg2, e.g., Msg2-PDCCH or Msg2-PDSCH.

For receiving a single RAR after the last PRACH repetition or earlier, the properties of the transmission beam for Msg2, e.g., Msg2-PDCCH or Msg2-PDSCH, may be determined as follows:

The beam used for Msg2 (DM-RS of Msg2-PDCCH or Msg2-PDSCH) has the same QCL properties for a particular SSB/CSI-RS associated with particular PRACH repetitions determined according to a particular rule, a few examples of which are provided below.

The SSB associated with the last or the first PRACH transmission may be assumed to be the QCL source Reference Signal (RS) for Msg2. Also, the Random Access Radio Network Temporary Identifier (RA-RNTI) is determined based on the selected PRACH for determining which beam to be used for the reception of Msg2.

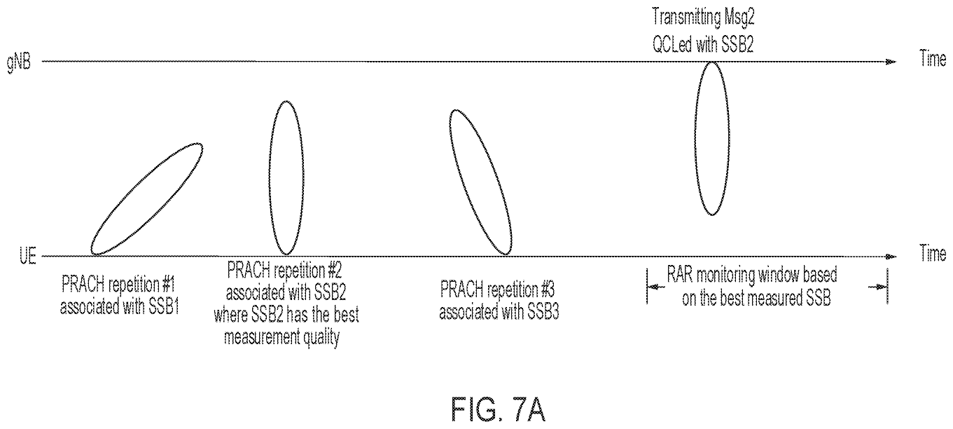

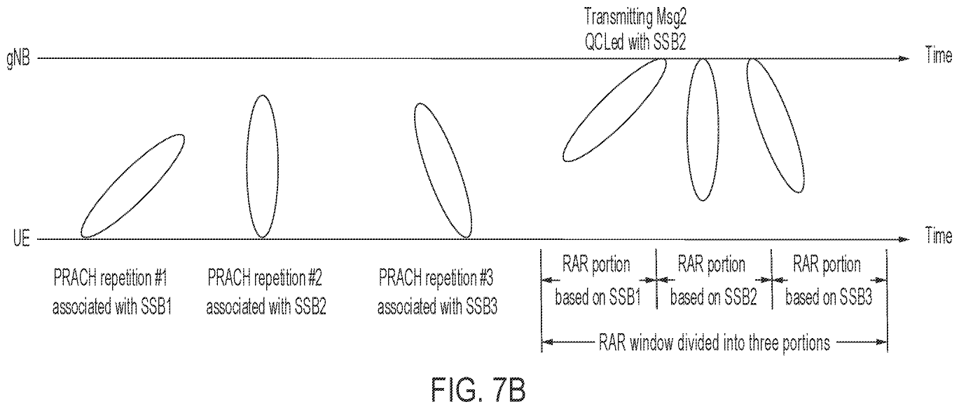

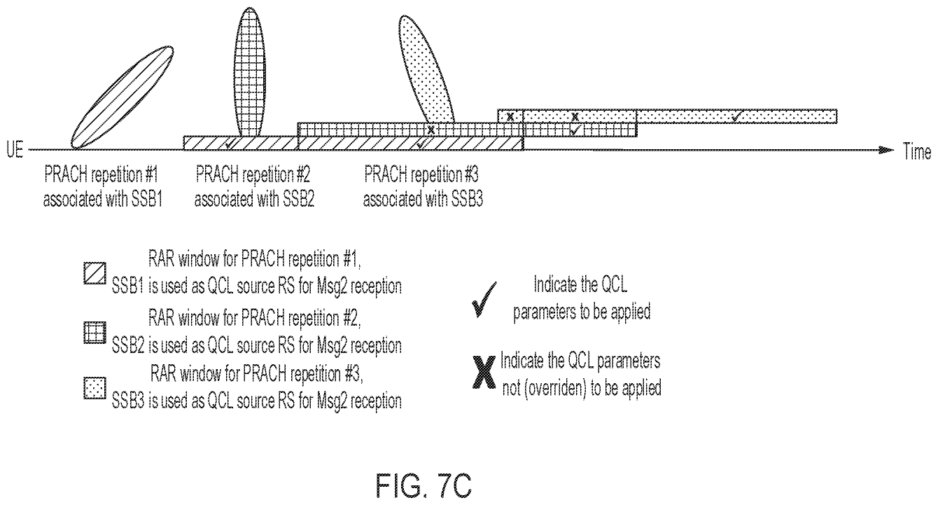

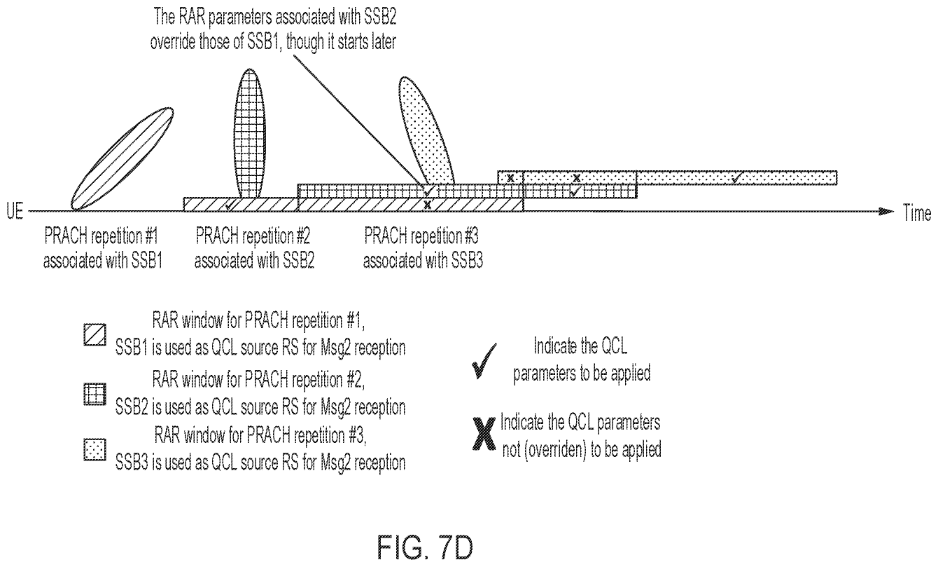

Since the PRACH repetitions may be associated with different SSBs, each has different measurement quality such as RSRP. Because of the channel reciprocity, the best measured SSB beam at the UE-side will correspond to the best measured PRACH at the gNB side. In this case, it is beneficial that this beam, i.e., the beam corresponding to the best measured SSB, may be used for Msg2 transmission to increase the probability of correct reception of Msg2. This is exemplified in FIG. 7A in which SSB2 is determined to be the SSB with the best measurement quality and the UE assumes that SSB2 is the QCL source RS for Msg2. Also, the RA-RNTI is determined based on the selected PRACH associated with the best measured SSB.

Another possibility is that the UE tries to receive Msg2 in RAR window using different beams in different portion of the RAR window. As one possibility, assuming L PRACH repetitions are transmitted, the RAR window is divided into “L” equal portions. In each portion, the UE assumes that Msg2's beam has the same QCL properties of one of the SSBs associated with PRACH repetition. Specifically, for the PDCCH monitoring occasions that fall within particular portion of the RAR window, the UE assumes the SSB associated with this portion is used as the QCL reference signal for the reception of Msg2. The beams for Msg2 reception in the RAR window may have the same order as the transmitted PRACH as shown in FIG. 7B. It is worth mentioning that the UE is not require monitor each portion within RAR window once the UE successfully receives any of the RAR responses in any of the earlier portions of the RAR window. In each portion, the RA-RNTI is determined based on the selected PRACH. The transmitted PRACH repetition may be ordered based on its transmission location in the time domain, frequency domain, RACH occasion index, preamble index. For example, the order can be first in increasing order of RACH occasion index in the frequency domain, second in increasing order of PRACH occasion index in time domain, etc.

For receiving multiple RARs for each transmitted PRACH repetition associated with different SSBs, the legacy approach may be applied to determine the beam properties of Msg2 in each RAR, i.e., determining Msg2's beam is QCLed source RS. However, it may happen that the RAR window associated with different transmitted PRACH are overlapped in the time domain. In this case, it is important to define what assumption regarding the QCL source RS should be made within the overlapped portion of the RAR windows. To handle this case, any of the following two possibilities may be applied.

A first possibility is that the UE does not expect RAR windows to overlap when they correspond to different PRACH repetitions associated with different SSBs. However, if the PRACH repetitions are associated with the same SSB, it may be allowed to have overlapped RARs as the UE does not need to adjust the receive beam based on the beam properties of Msg2.

A second possibility is that if the RAR windows that correspond to different PRACH repetitions associated with different SSB are overlapped, any of the following procedures may be applied.

In the non-overlapped portions of RAR, the QCL source RS is determined similar to legacy mechanism, i.e., Msg2's beam has the same properties as the SSB/CSI-RS associated with the PRACH repetition of which the RAR is monitored in RAR window.

In the overlapped portions of RAR, the QCL source RS may be based on the RAR window started earlier. This is shown FIG. 7C where the QCL assumption of the RAR window that starts earlier overrides the QCL assumptions of the RAR windows that start later. Other parameters associated with the earlier start RAR window may override those of the later RAR such as RA-RNTI that the UE may apply.

Other rules may be applied to determine the QCL assumption for Msg2 reception and the corresponding RNTI in the overlapped portion of the RAR windows. For example, the determination may be based on the measured quality of the SSB associated with RAR window. Revisiting the previous example and assuming that measured SSB quality (e.g., RSRP) are as follows, RSRP_{SSB1}<RSRP_{SSB3}<RSRP_{SSB2}, i.e., SSB2 has the best measured quality followed by SSB3 then SSB1, the parameters related to the RAR window associated with SSB2, such as the QCL assumption and RA-RNTI, override the parameters associated with other RAR windows as exemplified in FIG. 7D.

Beam handling for Msg3 transmission may be performed as follows. To ensure that the UE and the gNB have a common understanding of which transmit beam is to be used for Msg3 at the UE side and Rx beam at the gNB side, the transmit beam of Msg3 may be the same as the PRACH transmit beam which is associated with the received RAR carrying the Msg3 grant. Also, the SSB associated with that PRACH repetition may be used to determine the transmit beam of Msg3 because of the channel reciprocity between DL and UL.

To provide more flexibility, the gNB may indicate to the UE which beam should be used when transmitting Msg3. This solution may be beneficial, for example, when the UE transmits multiple PRACH repetitions associated with the different SSBs and the earliest RAR window does not correspond to the best transmit beam at the UE side. In this case, the gNB may use the previously transmitted PRACH repetitions or their associated SSBs to indicate the transmit beam of Msg3.

For example, a new field in the RAR itself may be used to indicate the beam of Msg3. The bitwidth of this field may be equal to the number of configured PRACH repetitions. In this case, the field may indicate the beam of which PRACH repetition that may be used for transmitting Msg3. The PRACH repetitions may be indexed as described in this disclosure or any other method. Alternatively, the gNB may indicate the SSB index which the UE should use to determine the transmit beam of Msg3 relying on the reciprocity between DL and UL. In this case, the field size may depend on the number of transmitted SSBs.

Also, this field may be in the Msg2-PDCCH rather than in the RAR itself. In this case, the indicated transmit beam for Msg3 may be applied by all UEs that may find preamble ID in the scheduled RARs. This field may be similar to the previous fields that either indicate the PRACH repetition or SSB that should be used determine the transmit beam of Msg3. This is beneficial when the gNB attempts to use a single receive beam for Msg3 for all UEs provided by RARs in a single Msg2.

For Msg3 re-transmission, scheduled by DCI 0_0 with CRC scrambled by Temporary Cell RNTI (TC-RNTI), a field similar to the aforementioned field may be included in DCI 0_0 to indicate which PRACH repetition or the associated SSB to be used for determining the beam of Msg3. For example, in this DCI, the NDI and HARQ fields are reserved and they may be repurposed for indicating which beam should be applied for Msg3 re-transmission as described above. Alternatively, a new field may be introduced to indicate the beam for Msg3.

Another option for determining the beam for Msg3 retransmission is that the same beam indicated in the initial transmission by Msg2 (Msg2-PDCCH or Msg2-PDSCH) may still be applied in case of Msg3 retransmission.

Beam handling for Msg4 reception may be performed as follows. If the UE receives a single Msg2, then the UE may assume that the same SSB used as QCL source RS for Msg2 is the one that should be assumed as the QCL source RS for Msg4. In other words, the DM-RS of PDCCH scheduling Msg4 has the same QCL properties as the SSB that the UE used for the reception Msg2. If there are multiple scheduled Msg2s QCLed with different SSBs and each one provides different RARs, the UE may select one of these RARs based on their quality, e.g., the RSRP of the Msg2-PDCCH or of the Msg2-PDSCH, based on the reception order in the time domain, etc., to determine the resources of Msg3. In this case, the UE may assume that the SSB used as QCL source RS for Msg2 that provided the used grant of Msg3 may be the QCL source RS for Msg4.

Configurations handling may be performed as follows. In legacy NR, the gNB may define multiple sets of features consisting of Reduced Capability (redcap), smallData, msg3-Repetition, etc., and indicate the associated set of preambles and ROs. For example, the gNB may configure the following feature sets S₀={redcap}, S₁={msg3-Repetition}, S₂={redcap, msg3-Repetition} and S₃={smallData, msg3-Repetition}. For each one, the gNB may indicate dedicated preambles by indicating the index of the first preamble and number of consecutive preambles per SSB to be associated with the features sets, e.g., S₀, S₁, S₂, or S₃. Also, the gNB may indicate a subset of ROs that may be used for each features set, e.g., S₀, S₁, S₂, or S₃.

Defining a new feature related to PRACH-repetition is a straightforward solution which may enable the gNB to combine this feature with other feature, if needed, and indicate the corresponding preambles. That is, FeatureCombination-r17 has multiple spare values one of which may be used of PRACH-repetition. This enables the gNB to define a feature set that consists of {PRACH-repetition, msg3-Repetition} and then use FeatureCombinationPreambles to configure common preamble resources for both features.

To keep the spare values for the future and exploit that the fact that if Msg3 needs repetitions, PRACH may need repetition as well, the set of preambles associated with PRACH repetition may be the same as the set of preambles to be used when requesting Msg3 repetitions.

Also, in legacy NR, the gNB may configure a unique priority index for each feature which may be used to determine the set of preambles to select from when a feature maps to more than on feature set, e.g., the feature msg3-Repetition is in S₁, S₂, and S₃. One possibility is to define a priority for the PRACH repetition feature. Alternatively, the UE may assume that PRACH repetition has the same priority as priority indicated to msg3-Repetition to reduce the signalling overhead. This is also meaningful when both msg3-Repetition and PRACH-repetition occur together. Also, in legacy NR, rsrp-ThresholdMsg3 is used by the UE to determine whether to select resources indicating whether or not Msg3 repetition is needed. This field is mandatory when the set of random access resources are configured for both Msg3 with repetition or Msg3 without repetition. As described in this disclosure, a dedicated RRC parameter, e.g., rsrp-thresholdPRACH may be separately configured such that the UE may use it to determine whether PRACH repetition is needed or not. However, if this parameter is not configured, the UE may use rsrp-ThresholdMsg3 to make a decision on the necessity for PRACH repetition in addition to its usage for determining whether or not the repetition is needed for Msg3.

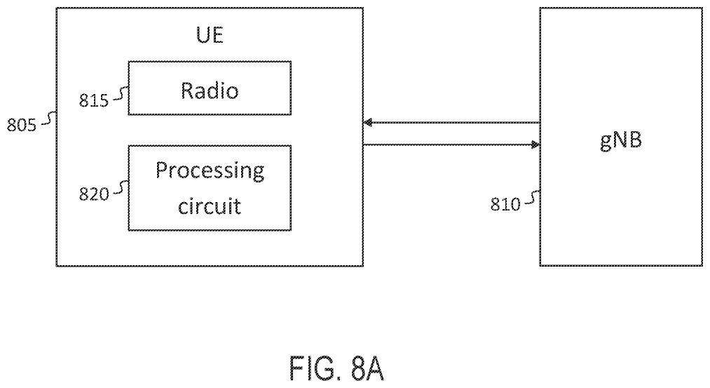

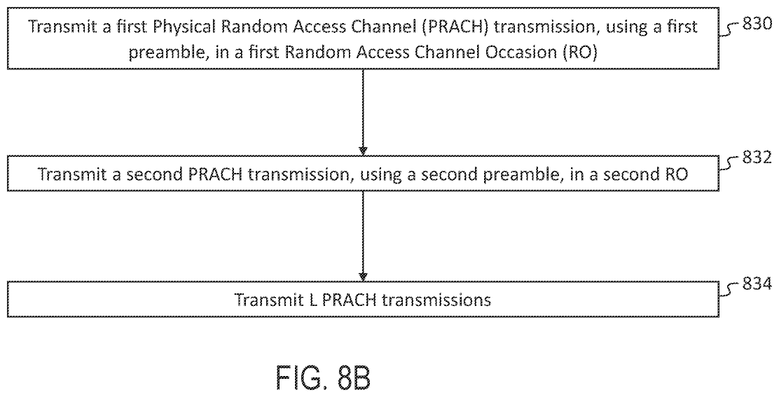

FIG. 8A shows a portion of a wireless system. A user equipment (UE) 805 sends transmissions to a network node (gNB) 810 and receives transmissions from the gNB 810. The UE includes a radio 815 and a processing circuit (or “processor”) 820. In operation, the processing circuit may perform various methods described herein, e.g., it may receive (via the radio, as part of transmissions received from the gNB 810) information from the gNB 810, and it may send (via the radio, as part of transmissions transmitted to the gNB 810) information to the gNB 810.

FIG. 8B is a flow chart of a method, in some embodiments. The method includes transmitting, at 830, by a User Equipment (UE), a first Physical Random Access Channel (PRACH) transmission, using a first preamble, in a first Random Access Channel Occasion (RO); and transmitting, at 832, by the UE, a second PRACH transmission, using a second preamble, in a second RO. The second PRACH transmission may be a repetition of the first PRACH transmission, and (i) the second RO may have an index differing from an index of the first RO by a set integer or (ii) the first preamble may be based on a first root sequence and be cyclically shifted by a first integer, and the second preamble may be based on the first root sequence and be cyclically shifted by a second integer differing from the first integer by a set integer. In some embodiments, the first RO is associated with a first Synchronization Signal Block (SSB) index, and the second RO is associated with the first SSB index. In some embodiments, the first RO is associated with a first SSB transmitted on a first downlink beam, and the second RO is associated with a second SSB transmitted on a second downlink beam, different from the first downlink beam. In some embodiments, the set integer is Radio Resource Control (RRC) configured. In some embodiments, the set integer is configured by a System Information Block. In some embodiments, the set integer is configured at startup of the UE. In some embodiments: the first PRACH transmission includes a first preamble, based on a first root sequence and being cyclically shifted by a first integer; and the second PRACH transmission includes a second preamble, based on the first root sequence and being cyclically shifted by a second integer differing from the first integer by a set integer.

The method may further include transmitting, at 834, L PRACH transmissions including: the first PRACH transmission; and L-1 PRACH retransmissions including the second PRACH transmission, the L PRACH transmissions being in one SSB-RO association period. In some embodiments, the L PRACH transmissions are made within a set of N′ ROs, the N′ ROs being a set proper subset of N available ROs. In some embodiments, the set proper subset is Radio Resource Control (RRC) configured. In some embodiments, the first RO is selected based on the value of L.

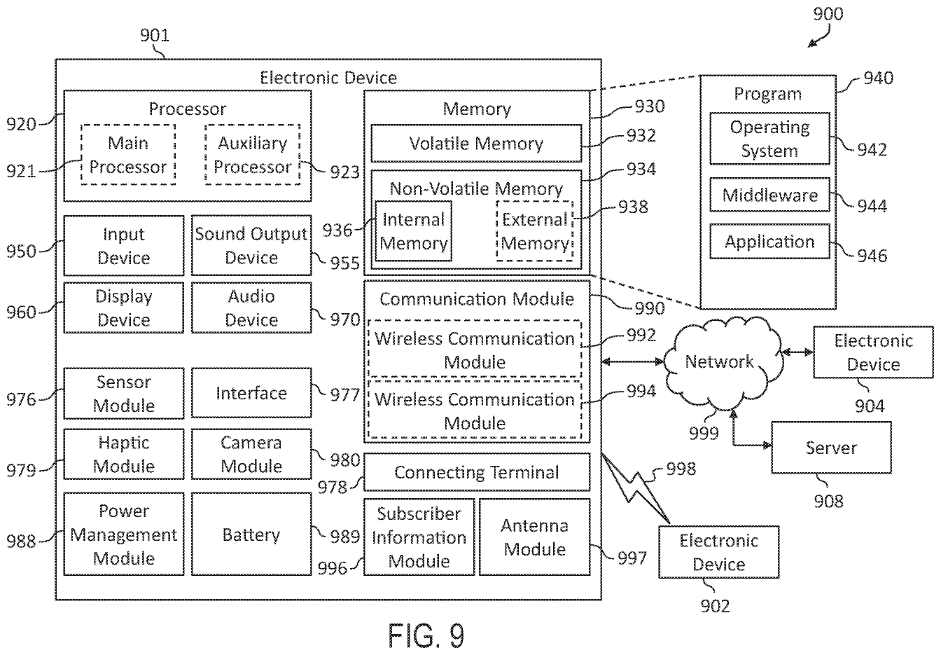

FIG. 9 is a block diagram of an electronic device in a network environment 900, according to an embodiment.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 940, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 994. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 946 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
transmitting, by a User Equipment (UE), a first Physical Random Access Channel (PRACH) transmission in a first Random Access Channel Occasion (RO); and
transmitting, by the UE, a second PRACH transmission in a second RO,
the second PRACH transmission being a repetition of the first PRACH transmission, the second RO having an index differing from an index of the first RO by a set integer.

2. The method of claim 1, wherein the first RO is associated with a first Synchronization Signal Block (SSB) index, and the second RO is associated with the first SSB index.

3. The method of claim 1, wherein the first PRACH transmission uses a first uplink (UL) beam, and the second PRACH transmission uses a second UL beam differing from the first UL beam.

4. The method of claim 1, wherein the set integer is Radio Resource Control (RRC) configured.

5. The method of claim 1, wherein the set integer is configured by a System Information Block.

6. The method of claim 1, wherein the set integer is configured at startup of the UE.

7. The method of claim 1, wherein:
the first PRACH transmission comprises a first preamble, having a first preamble index; and
the second PRACH transmission comprises a second preamble, having a second preamble index differing from the first preamble index by a set integer.

8. The method of claim 1, comprising transmitting L PRACH transmissions including:
the first PRACH transmission; and
L-1 PRACH repetitions including the second PRACH transmission,
the L PRACH transmissions being in one SSB-RO association period.

9. The method of claim 1, wherein the first PRACH transmission is made on one of N′ ROs, the N′ ROs being a set proper subset of N available ROs.

10. The method of claim 9, wherein the set proper subset is Radio Resource Control (RRC) configured.

11. The method of claim 9, comprising transmitting L PRACH transmissions including:
the first PRACH transmission; and
L-1 PRACH repetitions including the second PRACH transmission,
wherein the N′ ROs are selected based on the value of L.

12. A method, comprising:
transmitting, by a User Equipment (UE), a first Physical Random Access Channel (PRACH) transmission comprising a first preamble, in a first RO; and
transmitting, by the UE, a second PRACH transmission comprising a second preamble, in a second RO,
the second PRACH transmission being a repetition of the first PRACH transmission,
the first preamble being based on a first root sequence and being cyclically shifted by a first integer, and
the second preamble being based on the first root sequence and being cyclically shifted by a second integer differing from the first integer by a set integer.

13. The method of claim 12, comprising transmitting L PRACH transmissions including:
the first PRACH transmission; and
L-1 PRACH repetitions including the second PRACH transmission,
the L PRACH transmissions being in one SSB-RO association period.

14. The method of claim 12, wherein the first PRACH transmission is made on one of N′ ROs, the N′ ROs being a set proper subset of N available ROs.

15. The method of claim 14, wherein the set proper subset is Radio Resource Control (RRC) configured.

16. The method of claim 14, comprising transmitting L PRACH transmissions including:
the first PRACH transmission; and
L-1 PRACH repetitions including the second PRACH transmission, wherein the N′ ROs are selected based on the value of L.

17. A User Equipment (UE) comprising:
one or more processors; and
a memory storing instructions which, when executed by the one or more processors, cause performance of:
transmitting a first Physical Random Access Channel (PRACH) transmission in a first Random Access Channel Occasion (RO); and
transmitting a second PRACH transmission in a second RO,
the second PRACH transmission being a repetition of the first PRACH transmission, the second RO having an index differing from an index of the first RO by a set integer.

18. The UE of claim 17, wherein the first RO is associated with a first Synchronization Signal Block (SSB) index, and the second RO is associated with the first SSB index.

19. The UE of claim 17, wherein the first PRACH transmission uses a first uplink (UL) beam, and the second PRACH transmission uses a second UL beam differing from the first UL beam.

20. The UE of claim 17, wherein the set integer is Radio Resource Control (RRC) configured.
